(19) United States
(12) Patent Application Publication
(10) Pub. No.: US 2026/0308913 A1
(43) Pub. Date: Oct. 8, 2026

(54) ROOFING MATERIALS AND METHODS OF MAKING ROOFING MATERIALS FOR COLD TEMPERATURE INSTALLATION

(71) Applicant: BMIC LLC, Dallas, TX (US)

(72) Inventors: Ming-Liang Shiao, Collegeville, PA (US); Kevin McGrath, Denville, NJ (US); Zhengang Zong, Chester, NJ (US); Brian Lee, Cranford, NJ (US)

(21) Appl. No.: 19/461,916

(22) Filed: Jan. 28, 2026

Related U.S. Application Data
(60) Provisional application No. 63/750,819, filed on Jan. 29, 2025.

(51) Int. Cl. E04D 5/10; C08J 3/18; E04D 5/14

(52) U.S. Cl. CPC E04D 5/10; C08J 3/18; E04D 5/148

(57) ABSTRACT

This invention, in embodiments, relates to a method of preparing a roofing material that includes obtaining a substrate, obtaining an asphaltic coating composition, applying the asphaltic coating composition to a surface of the substrate to prepare a coated substrate, and applying a plasticizer composition to at least one of an upper surface or a lower surface of the coated substrate, such that the plasticizer composition penetrates into the substrate of the coated substrate. This invention, in embodiments, further relates to a roofing material, as well as a method of installing a roofing material.

This application claims the priority of U.S. provisional application Ser. No. U.S. 63/750,819 entitled “Roofing Materials and Methods of Making Roofing Materials for Cold Temperature Installation” filed Jan. 29, 2025, which is incorporated herein by reference in its entirety for all purposes.

### FIELD OF THE INVENTION

This invention relates to roofing materials and methods of making roofing materials with enhanced performance for installation at cold temperatures. The methods include applying a plasticizer composition during the process of preparing the roofing materials.

### BACKGROUND OF THE INVENTION

Typically, roofing materials, such as, e.g., shingles, are produced by applying a coating or a molten material (e.g., an asphalt-based composition) to a substrate, such as, e.g., a fiberglass or felt mat.

### SUMMARY OF THE INVENTION

One embodiment of this invention pertains to a method of preparing a roofing material that includes obtaining a substrate, obtaining an asphaltic coating composition, applying the asphaltic coating composition to a surface of the substrate to prepare a coated substrate, and applying a plasticizer composition to at least one of an upper surface or a lower surface of the coated substrate, such that the plasticizer composition penetrates into the substrate of the coated substrate.

In one embodiment, the applying the plasticizer composition to at least one of an upper surface or a lower surface of the coated substrate is conducted prior to installation of the roofing material on a roof deck.

In one embodiment, the plasticizer composition is applied to the lower surface of the coated substrate.

In one embodiment, the plasticizer composition is applied to both the upper surface and the lower surface of the coated substrate.

In one embodiment, the method further comprises applying at least one of roofing granules, fines, back surfacers, surfacing media, or a combination thereof to at least one of the upper surface or the lower surface of the coated substrate. In another embodiment, the applying the plasticizer composition to at least one of an upper surface or a lower surface of the coated substrate is conducted after the applying at least one of roofing granules, fines, back surfacers, surfacing media, or a combination thereof to at least one of the upper surface or the lower surface of the coated substrate.

In one embodiment, the applying the plasticizer composition to at least one of an upper surface or a lower surface of the coated substrate is conducted by roll coating, spraying, brush coating, dip coating, electrostatic spraying, curtain coating, or combinations thereof.

In one embodiment, the plasticizer composition comprises at least one of a low molecular weight oil, naphthenic oil, paraffin oil, mineral oil, cooking oil, olive oil, soybean oil, cashew nut oil or a derivative thereof, flax oil, a plant-derived oil, recycled oil, synthetic triglyceride (oil), epoxidized soybean oil, epoxidized corn oil, partially or fully epoxidized plant-derived oil, epoxidized isoamyl soyate, epoxidized benzyl soyate, epoxidized methyl soyate, epoxidized soy fatty acid esters, or combinations thereof.

In one embodiment, the plasticizer composition comprises a surfactant. In another embodiment, the surfactant comprises at least one of a cationic surfactant, a nonionic surfactant, an anionic surfactant, a zwitterionic surfactant, or a combination thereof.

In one embodiment, the plasticizer composition comprises at least one of a viscosity modifier, a surfactant, a biocide, a tackifier, or combinations thereof.

In one embodiment, the plasticizer composition comprises a water-based emulsion at a concentration of from 5% to 20%. In one embodiment, the plasticizer composition comprises a water-based emulsion at a concentration of 5%. In one embodiment, the plasticizer composition comprises a water-based emulsion at a concentration of 20%.

In one embodiment, the applying the plasticizer composition to at least one of an upper surface or a lower surface of the coated substrate is conducted by applying from 0.001 wt % to 0.05 wt % of the plasticizer composition based on a total weight of the roofing material.

In one embodiment, the substrate comprises one of a fiberglass mat, a polyester mat, a scrim, a membrane, or a combination thereof.

In one embodiment, the applying the plasticizer composition to at least one of an upper surface or a lower surface of the coated substrate is conducted prior to laminating of the roofing material.

In one embodiment, the applying the plasticizer composition to at least one of an upper surface or a lower surface of the coated substrate is conducted prior to applying a sealant or adhesive to at least one of the upper surface or the lower surface of the coated substrate. In one embodiment, the roofing material comprises a roofing shingle.

In one embodiment, the roofing material exhibits increased flexibility at temperatures of 40° F. or lower, as compared to a roofing material prepared without applying a plasticizer composition.

Another embodiment of this invention pertains to a roofing material prepared by the method described above.

Yet another embodiment of this invention pertains to a method of installing a roofing material that includes obtaining a plurality of roofing materials, with each roofing material of the plurality of roofing materials comprising a coated substrate to which a plasticizer composition has been applied to at least one of an upper surface or a lower surface of the coated substrate, such that the plasticizer composition penetrates into a substrate of the coated substrate, and applying the plurality of roofing materials to a roof deck.

In one embodiment, the coated substrate comprises a substrate that is coated with an asphaltic coating composition.

In one embodiment, the substrate comprises one of a fiberglass mat, a polyester mat, a scrim, a membrane, or a combination thereof.

In one embodiment, the plasticizer composition is applied to the lower surface of the coated substrate.

In one embodiment, the plasticizer composition is applied to both the upper surface and the lower surface of the coated substrate.

In one embodiment, each roofing material of the plurality of roofing materials further comprises at least one of roofing granules, fines, back surfacers, surfacing media, or a combination thereof applied to at least one of the upper surface or the lower surface of the coated substrate.

In one embodiment, the plasticizer composition comprises at least one of a low molecular weight oil, naphthenic oil, paraffin oil, mineral oil, cooking oil, olive oil, soybean oil, cashew nut oil or a derivative thereof, flax oil, a plant-derived oil, recycled oil, synthetic triglyceride (oil), epoxidized soybean oil, epoxidized corn oil, partially or fully epoxidized plant-derived oil, epoxidized isoamyl soyate, epoxidized benzyl soyate, epoxidized methyl soyate, epoxidized soy fatty acid esters, or combinations thereof.

In one embodiment, the plasticizer composition comprises a surfactant. In another embodiment, the surfactant comprises at least one of a cationic surfactant, a nonionic surfactant, an anionic surfactant, a zwitterionic surfactant, or a combination thereof.

In one embodiment, the plasticizer composition comprises at least one of a viscosity modifier, a surfactant, a biocide, a tackifier, or combinations thereof.

In one embodiment, the plasticizer composition comprises a water-based emulsion at a concentration of from 5% to 20%. In one embodiment, the plasticizer composition comprises a water-based emulsion at a concentration of 5%. In one embodiment, the plasticizer composition comprises a water-based emulsion at a concentration of 20%.

In one embodiment, the plasticizer composition is applied to at least one of an upper surface or a lower surface of the coated substrate in an amount of from 0.001 wt % to 0.05 wt % based on a total weight of the roofing material.

In one embodiment, each roofing material of the plurality of roofing materials further comprises a sealant or adhesive that is applied to at least one of the upper surface or the lower surface of the coated substrate.

In one embodiment, each roofing material of the plurality of roofing materials exhibits increased flexibility when installed at temperatures of 40° F. or lower, as compared to a roofing material that does not include a plasticizer composition.

Another embodiment of this invention pertains to a bundle of roofing materials that includes a plurality of roofing materials, with each roofing material of the plurality of roofing materials comprising a coated substrate to which a plasticizer composition has been applied to at least one of an upper surface or a lower surface of the coated substrate, such that the plasticizer composition penetrates into a substrate of the coated substrate. According to one embodiment, each roofing material of the plurality of roofing materials is configured to be installed on a roof deck at temperatures of 40° F. or lower.

In one embodiment, the coated substrate comprises a substrate that is coated with an asphaltic coating composition.

In one embodiment, the substrate comprises one of a fiberglass mat, a polyester mat, a scrim, a membrane, or a combination thereof.

In one embodiment, the plasticizer composition is applied to the lower surface of the coated substrate.

In one embodiment, the plasticizer composition is applied to both the upper surface and the lower surface of the coated substrate.

In one embodiment, each roofing material of the plurality of roofing materials further comprises at least one of roofing granules, fines, back surfacers, surfacing media, or a combination thereof applied to at least one of the upper surface or the lower surface of the coated substrate.

In one embodiment, the plasticizer composition comprises at least one of a low molecular weight oil, naphthenic oil, paraffin oil, mineral oil, cooking oil, olive oil, soybean oil, cashew nut oil or a derivative thereof, flax oil, a plant-derived oil, recycled oil, synthetic triglyceride (oil), epoxidized soybean oil, epoxidized corn oil, partially or fully epoxidized plant-derived oil, epoxidized isoamyl soyate, epoxidized benzyl soyate, epoxidized methyl soyate, epoxidized soy fatty acid esters, or combinations thereof.

In one embodiment, the plasticizer composition comprises a surfactant. In another embodiment, the surfactant comprises at least one of a cationic surfactant, a nonionic surfactant, an anionic surfactant, a zwitterionic surfactant, or a combination thereof.

In one embodiment, the plasticizer composition comprises at least one of a viscosity modifier, a surfactant, a biocide, a tackifier, or combinations thereof.

In one embodiment, the plasticizer composition comprises a water-based emulsion at a concentration of from 5% to 20%. In one embodiment, the plasticizer composition comprises a water-based emulsion at a concentration of 5%. In one embodiment, the plasticizer composition comprises a water-based emulsion at a concentration of 20%.

In one embodiment, the plasticizer composition is applied to at least one of an upper surface or a lower surface of the coated substrate in an amount of from 0.001 wt % to 0.05 wt % based on a total weight of the roofing material.

In one embodiment, each roofing material of the plurality of roofing materials further comprises a sealant or adhesive that is applied to at least one of the upper surface or the lower surface of the coated substrate.

In one embodiment, each roofing material of the plurality of roofing materials exhibits increased flexibility when installed at temperatures of 40° F. or lower, as compared to a roofing material that does not include a plasticizer composition.

### BRIEF DESCRIPTION OF THE FIGURES

For a more complete understanding of the invention and the advantages thereof, reference is made to the following descriptions, taken in conjunction with the accompanying figures, in which:

FIG. 1 is an illustration of a method of preparing a roofing material according to an embodiment of the invention.

FIG. 2 is an illustration of a prepared roofing material according to an embodiment of the invention.

FIG. 3 is an illustration of a prepared roofing material according to an embodiment of the invention.

FIG. 4 is an illustration of a prepared roofing material according to an embodiment of the invention.

FIG. 5 is a graph illustrating the amount of distortion of prepared roofing materials over time according to an embodiment of the invention.

FIG. 6 is a graph illustrating the amount of distortion of prepared roofing materials over time according to an embodiment of the invention.

FIG. 7 is a photograph of a test board for use in a lay-flat test method of prepared roofing materials according to an embodiment of the invention.

FIG. 8 is a photograph showing the creation of a distortion in prepared roofing materials for a lay-flat test method according to an embodiment of the invention.

FIG. 9 is an example of a Table for recording height and temperature of prepared roofing materials when conducting a lay-flat test method according to an embodiment of the invention.

### DETAILED DESCRIPTION OF THE INVENTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

As used herein, terms such as “consisting of” limit the scope of a specific claim to the materials and steps recited by the claim.

All prior patents, publications, and test methods referenced herein are incorporated by reference in their entireties.

As used herein, the term “coated substrate” means a substrate that is coated on one side (upper surface or lower surface) or both sides (upper surface and lower surface) with a coating composition.

As used herein, the term “uncoated substrate” means a substrate that has not been coated on any side (upper surface and/or lower surface) with a coating composition.

As used herein, the term “roofing material” includes, but is not limited to, shingles, roofing membranes, including, e.g., waterproofing membranes, and underlayment.

As used herein, the term “cold temperature(s)” means a temperature of 40° F. or lower.

As used herein, the term “aqueous” means a composition that includes some amount of water.

This invention relates to a method of preparing roofing materials (e.g., roofing shingles and other roofing materials) that includes applying a plasticizer composition in order to prepare roofing materials with enhanced performance for installation at cold temperatures. In addition, according to embodiments described herein, this invention provides improved installability of roofing materials, including, e.g., asphaltic shingles, in cold weather. Typically, asphaltic shingles that do not contain polymer modifications (e.g., polymer modified asphalt (PMA)) are known to become rigid, may not conform to a roof deck, and/or may not lay flat during roofing installations in cold weather, e.g., where the ambient temperature is 40° F. or lower. This may result in poor wind performance and also raise aesthetic concerns. By treating the roofing materials (e.g., roofing shingles) with plasticizers at relatively low concentrations and/or with certain oil-based emulsions during the shingle making process, the plasticizer can allow for the roofing materials to be flexible at low temperatures prior to the roofing installation. According to some embodiments, the plasticizer amount applied can be relatively low since it is only needed during installation, as long as its effectiveness can be preserved after some period of storage. The ability of the roofing material (e.g., roofing shingle) to conform to the roof deck can not only improve the aesthetics of the installed shingles, but also improve the cold wind performance by having sealants contacting the underlying shingles to provide initial tack.

Thus, according to one embodiment, non-PMA roofing materials (e.g., roofing shingles) are provided that have improved flexibility and the ability to lay flat during installation to a roof deck in cold weather, such as, e.g., at temperatures of 40° F. or lower. By providing roofing materials (e.g., roofing shingles) that do not contain polymer modified asphalt (PMA) coatings, the costs associated with such PMA coatings can be reduced.

As described above, during cold weather installations, roofing materials, such as, e.g., asphaltic shingles, tend to be less flexible and are more difficult to handle due to the stiffness/brittleness of the shingles. Also, during cold weather installation, roofing materials (e.g., roofing shingles) may have distortions due to unevenness of the thickness in a pallet and may not conform to the roof deck when installed (also known as “not laying flat”), since the roofing materials may not be as flexible in cold weather. This can create wavy looks and gaps between shingle courses. As a result, sealants applied to the roofing materials (e.g., roofing shingles) may not be able to make contact with the roofing material and/or shingle underneath, such that the sealants cannot provide the needed uplift resistance for adequate wind performance. In a prolonged cold season or in colder regions, this may result in poor wind performance or shingle blow-off from the roof.

Therefore, there exists a need to prepare a roofing material (e.g., roofing shingle) that can maintain flexibility during cold weather installation to enhance shingle performance and aesthetics. Typically, this can be achieved by modifying an asphaltic coating for a roofing material with soft polymers or rubbers, such as, e.g., SBS, APP, or EDBS, to prepare a PMA coating that can impart flexibility at cold temperatures. However, this process can not only increase the difficulty of shingle making due to the need of high shear mixing, but also significantly increases the cost of the materials. Hence, it is desirable to have other solutions that can improve flexibility of the roofing material (e.g., roofing shingle) with the ability to be easily added to the roofing materials during the manufacturing process and/or for a lower cost solution.

According to embodiments described herein, the flexibility of a roofing material (e.g., roofing shingle) in cold weather can be achieved by adding plasticizers to the roofing material during the manufacturing process. According to one embodiment, this can be achieved by preparing, e.g., water-based emulsions comprising suitable plasticizers at relatively low concentrations and applying the emulsions during the shingle making process to impart the flexibility.

One embodiment of this invention pertains to a method of preparing a roofing material that includes obtaining a substrate, obtaining an asphaltic coating composition, applying the asphaltic coating composition to a surface of the substrate to prepare a coated substrate, and applying a plasticizer composition to at least one of an upper surface or a lower surface of the coated substrate, such that the plasticizer composition penetrates into the substrate of the coated substrate.

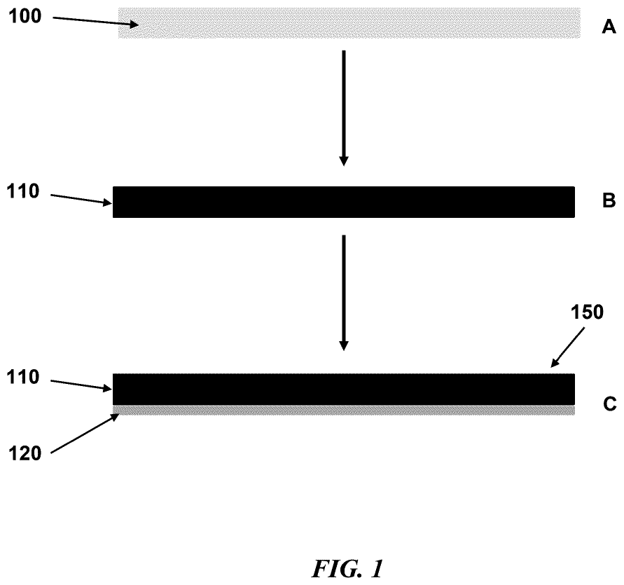

For example, FIG. 1 is an illustration of a method of preparing a roofing material according to an embodiment of the invention. As shown in FIG. 1, in step A, a substrate 100 is obtained. Thereafter, in step B, an asphaltic coating composition is obtained and applied to a surface of the substrate 100 of step A to thereby prepare a coated substrate 110. In step C, a plasticizer composition 120 is then applied to at least a lower surface of the coated substrate 110 to thereby prepare an exemplary roofing material 150, such that the plasticizer composition 120 penetrates into the substrate 100 of the coated substrate 110.

In one embodiment, the applying the plasticizer composition to at least one of an upper surface or a lower surface of the coated substrate is conducted prior to installation of the roofing material on a roof deck.

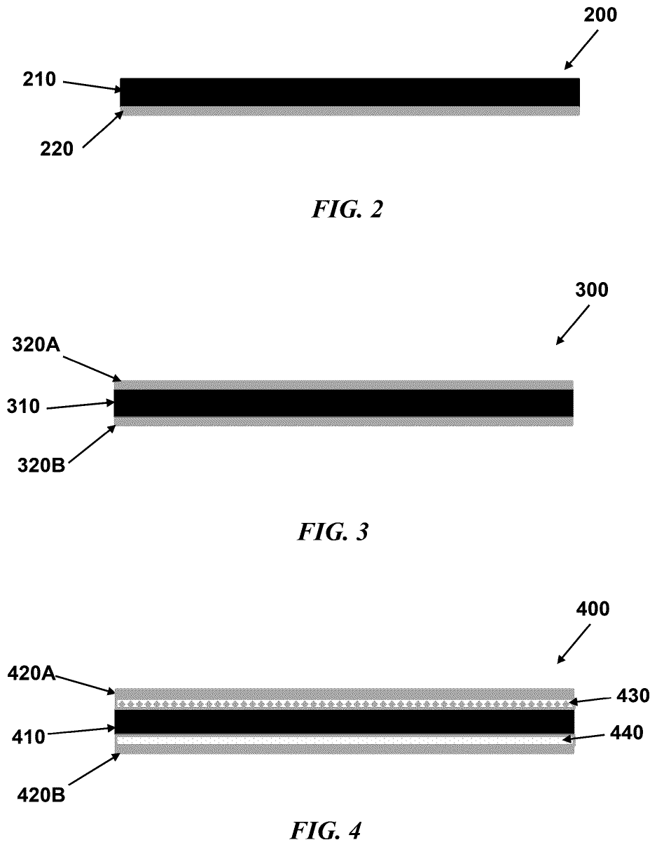

In one embodiment, the plasticizer composition is applied to the lower surface of the coated substrate. For example, FIG. 2 illustrates a prepared roofing material according to an embodiment of the invention, in which a roofing material 200 comprises a coated substrate 210 having a plasticizer composition 220 applied to the lower surface of the coated substrate 210.

In one embodiment, the plasticizer composition is applied to the upper surface of the coated substrate.

In another embodiment, the plasticizer composition is applied to both the upper surface and the lower surface of the coated substrate. For example, FIG. 3 illustrates a prepared roofing material according to an embodiment of the invention, in which a roofing material 300 comprises a coated substrate 310 having a plasticizer composition 320A applied to the upper surface of the coated substrate 310 and a plasticizer composition 320B applied to the lower surface of the coated substrate 310.

In one embodiment, the method further comprises applying at least one of roofing granules, fines, back surfacers, surfacing media, or a combination thereof to at least one of the upper surface or the lower surface of the coated substrate. In another embodiment, the applying the plasticizer composition to at least one of an upper surface or a lower surface of the coated substrate is conducted after the applying at least one of roofing granules, fines, back surfacers, surfacing media, or a combination thereof to at least one of the upper surface or the lower surface of the coated substrate. For example, FIG. 4 illustrates a prepared roofing material according to an embodiment of the invention, in which a roofing material 400 comprises a coated substrate 410 having (i) a plurality of granules 430 applied to an upper surface of the coated substrate 410, (ii) a plasticizer composition 420A applied to the granules 430 on the upper surface of the coated substrate 410, (iii) a plurality of fines 440 applied to a lower surface of the coated substrate 410, and (iv) a plasticizer composition 420B applied to the fines 440 on the lower surface of the coated substrate 410.

In one embodiment, the applying the plasticizer composition to at least one of an upper surface or a lower surface of the coated substrate is conducted by roll coating, spraying, brush coating, dip coating, electrostatic spraying, curtain coating, or combinations thereof.

In one embodiment, the plasticizer composition comprises at least one of a low molecular weight oil, naphthenic oil, paraffin oil, mineral oil, cooking oil, olive oil, soybean oil, cashew nut oil or a derivative thereof, flax oil, a plant-derived oil, recycled oil, synthetic triglyceride (oil), epoxidized soybean oil, epoxidized corn oil, partially or fully epoxidized plant-derived oil, epoxidized isoamyl soyate, epoxidized benzyl soyate, epoxidized methyl soyate, epoxidized soy fatty acid esters, or combinations thereof.

In one embodiment, the plasticizer composition comprises a surfactant. In another embodiment, the surfactant comprises at least one of a cationic surfactant, a nonionic surfactant, an anionic surfactant, a zwitterionic surfactant, or a combination thereof. According to one embodiment, a surfactant is added to the plasticizer composition to improve the stability of the plasticizer composition (e.g., emulsion).

In one embodiment, the plasticizer composition comprises an emulsion.

In one embodiment, the plasticizer composition is water-based (e.g., aqueous). In one embodiment, the plasticizer composition comprises a water-based emulsion.

In one embodiment, the plasticizer composition comprises a water-based emulsion at a concentration of from 1% to 100%. In one embodiment, the plasticizer composition comprises a water-based emulsion at a concentration of from 5% to 100%. In one embodiment, the plasticizer composition comprises a water-based emulsion at a concentration of from 10% to 100%. In one embodiment, the plasticizer composition comprises a water-based emulsion at a concentration of from 20% to 100%. In one embodiment, the plasticizer composition comprises a water-based emulsion at a concentration of from 30% to 100%. In one embodiment, the plasticizer composition comprises a water-based emulsion at a concentration of from 40% to 100%. In one embodiment, the plasticizer composition comprises a water-based emulsion at a concentration of from 50% to 100%. In one embodiment, the plasticizer composition comprises a water-based emulsion at a concentration of from 60% to 100%. In one embodiment, the plasticizer composition comprises a water-based emulsion at a concentration of from 70% to 100%. In one embodiment, the plasticizer composition comprises a water-based emulsion at a concentration of from 80% to 100%. In one embodiment, the plasticizer composition comprises a water-based emulsion at a concentration of from 90% to 100%. In one embodiment, the plasticizer composition comprises a water-based emulsion at a concentration of from 1% to 90%. In one embodiment, the plasticizer composition comprises a water-based emulsion at a concentration of from 5% to 90%. In one embodiment, the plasticizer composition comprises a water-based emulsion at a concentration of from 10% to 90%. In one embodiment, the plasticizer composition comprises a water-based emulsion at a concentration of from 20% to 90%. In one embodiment, the plasticizer composition comprises a water-based emulsion at a concentration of from 30% to 90%. In one embodiment, the plasticizer composition comprises a water-based emulsion at a concentration of from 40% to 90%. In one embodiment, the plasticizer composition comprises a water-based emulsion at a concentration of from 50% to 90%. In one embodiment, the plasticizer composition comprises a water-based emulsion at a concentration of from 60% to 90%. In one embodiment, the plasticizer composition comprises a water-based emulsion at a concentration of from 70% to 90%. In one embodiment, the plasticizer composition comprises a water-based emulsion at a concentration of from 80% to 90%. In one embodiment, the plasticizer composition comprises a water-based emulsion at a concentration of from 1% to 80%. In one embodiment, the plasticizer composition comprises a water-based emulsion at a concentration of from 5% to 80%. In one embodiment, the plasticizer composition comprises a water-based emulsion at a concentration of from 10% to 80%. In one embodiment, the plasticizer composition comprises a water-based emulsion at a concentration of from 20% to 80%. In one embodiment, the plasticizer composition comprises a water-based emulsion at a concentration of from 30% to 80%. In one embodiment, the plasticizer composition comprises a water-based emulsion at a concentration of from 40% to 80%. In one embodiment, the plasticizer composition comprises a water-based emulsion at a concentration of from 50% to 80%. In one embodiment, the plasticizer composition comprises a water-based emulsion at a concentration of from 60% to 80%. In one embodiment, the plasticizer composition comprises a water-based emulsion at a concentration of from 70% to 80%. In one embodiment, the plasticizer composition comprises a water-based emulsion at a concentration of from 1% to 70%. In one embodiment, the plasticizer composition comprises a water-based emulsion at a concentration of from 5% to 70%. In one embodiment, the plasticizer composition comprises a water-based emulsion at a concentration of from 10% to 70%. In one embodiment, the plasticizer composition comprises a water-based emulsion at a concentration of from 20% to 70%. In one embodiment, the plasticizer composition comprises a water-based emulsion at a concentration of from 30% to 70%. In one embodiment, the plasticizer composition comprises a water-based emulsion at a concentration of from 40% to 70%. In one embodiment, the plasticizer composition comprises a water-based emulsion at a concentration of from 50% to 70%. In one embodiment, the plasticizer composition comprises a water-based emulsion at a concentration of from 60% to 70%. In one embodiment, the plasticizer composition comprises a water-based emulsion at a concentration of from 1% to 60%. In one embodiment, the plasticizer composition comprises a water-based emulsion at a concentration of from 5% to 60%. In one embodiment, the plasticizer composition comprises a water-based emulsion at a concentration of from 10% to 60%. In one embodiment, the plasticizer composition comprises a water-based emulsion at a concentration of from 20% to 60%. In one embodiment, the plasticizer composition comprises a water-based emulsion at a concentration of from 30% to 60%. In one embodiment, the plasticizer composition comprises a water-based emulsion at a concentration of from 40% to 60%. In one embodiment, the plasticizer composition comprises a water-based emulsion at a concentration of from 50% to 60%. In one embodiment, the plasticizer composition comprises a water-based emulsion at a concentration of from 1% to 50%. In one embodiment, the plasticizer composition comprises a water-based emulsion at a concentration of from 5% to 50%. In one embodiment, the plasticizer composition comprises a water-based emulsion at a concentration of from 10% to 50%. In one embodiment, the plasticizer composition comprises a water-based emulsion at a concentration of from 20% to 50%. In one embodiment, the plasticizer composition comprises a water-based emulsion at a concentration of from 30% to 50%. In one embodiment, the plasticizer composition comprises a water-based emulsion at a concentration of from 40% to 50%. In one embodiment, the plasticizer composition comprises a water-based emulsion at a concentration of from 1% to 40%. In one embodiment, the plasticizer composition comprises a water-based emulsion at a concentration of from 5% to 40%. In one embodiment, the plasticizer composition comprises a water-based emulsion at a concentration of from 10% to 40%. In one embodiment, the plasticizer composition comprises a water-based emulsion at a concentration of from 20% to 40%. In one embodiment, the plasticizer composition comprises a water-based emulsion at a concentration of from 30% to 40%. In one embodiment, the plasticizer composition comprises a water-based emulsion at a concentration of from 1% to 30%. In one embodiment, the plasticizer composition comprises a water-based emulsion at a concentration of from 5% to 30%. In one embodiment, the plasticizer composition comprises a water-based emulsion at a concentration of from 10% to 30%. In one embodiment, the plasticizer composition comprises a water-based emulsion at a concentration of from 20% to 30%. In one embodiment, the plasticizer composition comprises a water-based emulsion at a concentration of from 1% to 20%. In one embodiment, the plasticizer composition comprises a water-based emulsion at a concentration of from 5% to 20%. In one embodiment, the plasticizer composition comprises a water-based emulsion at a concentration of from 10% to 20%. In one embodiment, the plasticizer composition comprises a water-based emulsion at a concentration of from 1% to 10%. In one embodiment, the plasticizer composition comprises a water-based emulsion at a concentration of from 5% to 10%. In one embodiment, the plasticizer composition comprises a water-based emulsion at a concentration of from 1% to 5%.

In one embodiment, the plasticizer composition comprises a water-based emulsion at a concentration of 5%. In one embodiment, the plasticizer composition comprises a water-based emulsion at a concentration of 20%.

In one embodiment, the plasticizer composition comprises other additives to improve the affinity to the asphaltic coatings.

In one embodiment, the plasticizer composition comprises at least one of a viscosity modifier, a surfactant, a biocide, a tackifier, or combinations thereof. According to one embodiment, the plasticizer composition comprises a viscosity modifier to enhance the ability for applying to surfaces of the roofing material (e.g., roofing shingle) during a high-speed shingle making process. In one embodiment, the plasticizer composition comprises a surfactant, a biocide, and/or a tackifier to improve the applicability to surfaces of the roofing material (e.g., roofing shingle).

In one embodiment, the amount of plasticizer composition applied to the roofing material (e.g., roofing shingle) should provide the roofing material with needed flexibility for cold installation, while not affecting the long-term performance of the roofing material.

In one embodiment, the applying the plasticizer composition to at least one of an upper surface or a lower surface of the coated substrate is conducted by applying from 0.001 wt % to 0.1 wt % of the plasticizer composition based on a total weight of the roofing material. In one embodiment, the applying the plasticizer composition to at least one of an upper surface or a lower surface of the coated substrate is conducted by applying from 0.003 wt % to 0.1 wt % of the plasticizer composition based on a total weight of the roofing material. In one embodiment, the applying the plasticizer composition to at least one of an upper surface or a lower surface of the coated substrate is conducted by applying from 0.005 wt % to 0.1 wt % of the plasticizer composition based on a total weight of the roofing material. In one embodiment, the applying the plasticizer composition to at least one of an upper surface or a lower surface of the coated substrate is conducted by applying from 0.008 wt % to 0.1 wt % of the plasticizer composition based on a total weight of the roofing material. In one embodiment, the applying the plasticizer composition to at least one of an upper surface or a lower surface of the coated substrate is conducted by applying from 0.01 wt % to 0.1 wt % of the plasticizer composition based on a total weight of the roofing material. In one embodiment, the applying the plasticizer composition to at least one of an upper surface or a lower surface of the coated substrate is conducted by applying from 0.02 wt % to 0.1 wt % of the plasticizer composition based on a total weight of the roofing material. In one embodiment, the applying the plasticizer composition to at least one of an upper surface or a lower surface of the coated substrate is conducted by applying from 0.03 wt % to 0.1 wt % of the plasticizer composition based on a total weight of the roofing material. In one embodiment, the applying the plasticizer composition to at least one of an upper surface or a lower surface of the coated substrate is conducted by applying from 0.04 wt % to 0.1 wt % of the plasticizer composition based on a total weight of the roofing material. In one embodiment, the applying the plasticizer composition to at least one of an upper surface or a lower surface of the coated substrate is conducted by applying from 0.05 wt % to 0.1 wt % of the plasticizer composition based on a total weight of the roofing material. In one embodiment, the applying the plasticizer composition to at least one of an upper surface or a lower surface of the coated substrate is conducted by applying from 0.06 wt % to 0.1 wt % of the plasticizer composition based on a total weight of the roofing material. In one embodiment, the applying the plasticizer composition to at least one of an upper surface or a lower surface of the coated substrate is conducted by applying from 0.07 wt % to 0.1 wt % of the plasticizer composition based on a total weight of the roofing material. In one embodiment, the applying the plasticizer composition to at least one of an upper surface or a lower surface of the coated substrate is conducted by applying from 0.08 wt % to 0.1 wt % of the plasticizer composition based on a total weight of the roofing material. In one embodiment, the applying the plasticizer composition to at least one of an upper surface or a lower surface of the coated substrate is conducted by applying from 0.09 wt % to 0.1 wt % of the plasticizer composition based on a total weight of the roofing material.

In one embodiment, the applying the plasticizer composition to at least one of an upper surface or a lower surface of the coated substrate is conducted by applying from 0.001 wt % to 0.09 wt % of the plasticizer composition based on a total weight of the roofing material. In one embodiment, the applying the plasticizer composition to at least one of an upper surface or a lower surface of the coated substrate is conducted by applying from 0.003 wt % to 0.09 wt % of the plasticizer composition based on a total weight of the roofing material. In one embodiment, the applying the plasticizer composition to at least one of an upper surface or a lower surface of the coated substrate is conducted by applying from 0.005 wt % to 0.09 wt % of the plasticizer composition based on a total weight of the roofing material. In one embodiment, the applying the plasticizer composition to at least one of an upper surface or a lower surface of the coated substrate is conducted by applying from 0.008 wt % to 0.09 wt % of the plasticizer composition based on a total weight of the roofing material. In one embodiment, the applying the plasticizer composition to at least one of an upper surface or a lower surface of the coated substrate is conducted by applying from 0.01 wt % to 0.09 wt % of the plasticizer composition based on a total weight of the roofing material. In one embodiment, the applying the plasticizer composition to at least one of an upper surface or a lower surface of the coated substrate is conducted by applying from 0.02 wt % to 0.09 wt % of the plasticizer composition based on a total weight of the roofing material. In one embodiment, the applying the plasticizer composition to at least one of an upper surface or a lower surface of the coated substrate is conducted by applying from 0.03 wt % to 0.09 wt % of the plasticizer composition based on a total weight of the roofing material. In one embodiment, the applying the plasticizer composition to at least one of an upper surface or a lower surface of the coated substrate is conducted by applying from 0.04 wt % to 0.09 wt % of the plasticizer composition based on a total weight of the roofing material. In one embodiment, the applying the plasticizer composition to at least one of an upper surface or a lower surface of the coated substrate is conducted by applying from 0.05 wt % to 0.09 wt % of the plasticizer composition based on a total weight of the roofing material. In one embodiment, the applying the plasticizer composition to at least one of an upper surface or a lower surface of the coated substrate is conducted by applying from 0.06 wt % to 0.09 wt % of the plasticizer composition based on a total weight of the roofing material. In one embodiment, the applying the plasticizer composition to at least one of an upper surface or a lower surface of the coated substrate is conducted by applying from 0.07 wt % to 0.09 wt % of the plasticizer composition based on a total weight of the roofing material. In one embodiment, the applying the plasticizer composition to at least one of an upper surface or a lower surface of the coated substrate is conducted by applying from 0.08 wt % to 0.09 wt % of the plasticizer composition based on a total weight of the roofing material.

In one embodiment, the applying the plasticizer composition to at least one of an upper surface or a lower surface of the coated substrate is conducted by applying from 0.001 wt % to 0.08 wt % of the plasticizer composition based on a total weight of the roofing material. In one embodiment, the applying the plasticizer composition to at least one of an upper surface or a lower surface of the coated substrate is conducted by applying from 0.003 wt % to 0.08 wt % of the plasticizer composition based on a total weight of the roofing material. In one embodiment, the applying the plasticizer composition to at least one of an upper surface or a lower surface of the coated substrate is conducted by applying from 0.005 wt % to 0.08 wt % of the plasticizer composition based on a total weight of the roofing material. In one embodiment, the applying the plasticizer composition to at least one of an upper surface or a lower surface of the coated substrate is conducted by applying from 0.008 wt % to 0.08 wt % of the plasticizer composition based on a total weight of the roofing material. In one embodiment, the applying the plasticizer composition to at least one of an upper surface or a lower surface of the coated substrate is conducted by applying from 0.01 wt % to 0.08 wt % of the plasticizer composition based on a total weight of the roofing material. In one embodiment, the applying the plasticizer composition to at least one of an upper surface or a lower surface of the coated substrate is conducted by applying from 0.02 wt % to 0.08 wt % of the plasticizer composition based on a total weight of the roofing material. In one embodiment, the applying the plasticizer composition to at least one of an upper surface or a lower surface of the coated substrate is conducted by applying from 0.03 wt % to 0.08 wt % of the plasticizer composition based on a total weight of the roofing material. In one embodiment, the applying the plasticizer composition to at least one of an upper surface or a lower surface of the coated substrate is conducted by applying from 0.04 wt % to 0.08 wt % of the plasticizer composition based on a total weight of the roofing material. In one embodiment, the applying the plasticizer composition to at least one of an upper surface or a lower surface of the coated substrate is conducted by applying from 0.05 wt % to 0.08 wt % of the plasticizer composition based on a total weight of the roofing material. In one embodiment, the applying the plasticizer composition to at least one of an upper surface or a lower surface of the coated substrate is conducted by applying from 0.06 wt % to 0.08 wt % of the plasticizer composition based on a total weight of the roofing material. In one embodiment, the applying the plasticizer composition to at least one of an upper surface or a lower surface of the coated substrate is conducted by applying from 0.07 wt % to 0.08 wt % of the plasticizer composition based on a total weight of the roofing material.

In one embodiment, the applying the plasticizer composition to at least one of an upper surface or a lower surface of the coated substrate is conducted by applying from 0.001 wt % to 0.07 wt % of the plasticizer composition based on a total weight of the roofing material. In one embodiment, the applying the plasticizer composition to at least one of an upper surface or a lower surface of the coated substrate is conducted by applying from 0.003 wt % to 0.07 wt % of the plasticizer composition based on a total weight of the roofing material. In one embodiment, the applying the plasticizer composition to at least one of an upper surface or a lower surface of the coated substrate is conducted by applying from 0.005 wt % to 0.07 wt % of the plasticizer composition based on a total weight of the roofing material. In one embodiment, the applying the plasticizer composition to at least one of an upper surface or a lower surface of the coated substrate is conducted by applying from 0.008 wt % to 0.07 wt % of the plasticizer composition based on a total weight of the roofing material. In one embodiment, the applying the plasticizer composition to at least one of an upper surface or a lower surface of the coated substrate is conducted by applying from 0.01 wt % to 0.07 wt % of the plasticizer composition based on a total weight of the roofing material. In one embodiment, the applying the plasticizer composition to at least one of an upper surface or a lower surface of the coated substrate is conducted by applying from 0.02 wt % to 0.07 wt % of the plasticizer composition based on a total weight of the roofing material. In one embodiment, the applying the plasticizer composition to at least one of an upper surface or a lower surface of the coated substrate is conducted by applying from 0.03 wt % to 0.07 wt % of the plasticizer composition based on a total weight of the roofing material. In one embodiment, the applying the plasticizer composition to at least one of an upper surface or a lower surface of the coated substrate is conducted by applying from 0.04 wt % to 0.07 wt % of the plasticizer composition based on a total weight of the roofing material. In one embodiment, the applying the plasticizer composition to at least one of an upper surface or a lower surface of the coated substrate is conducted by applying from 0.05 wt % to 0.07 wt % of the plasticizer composition based on a total weight of the roofing material. In one embodiment, the applying the plasticizer composition to at least one of an upper surface or a lower surface of the coated substrate is conducted by applying from 0.06 wt % to 0.07 wt % of the plasticizer composition based on a total weight of the roofing material.

In one embodiment, the applying the plasticizer composition to at least one of an upper surface or a lower surface of the coated substrate is conducted by applying from 0.001 wt % to 0.06 wt % of the plasticizer composition based on a total weight of the roofing material. In one embodiment, the applying the plasticizer composition to at least one of an upper surface or a lower surface of the coated substrate is conducted by applying from 0.003 wt % to 0.06 wt % of the plasticizer composition based on a total weight of the roofing material. In one embodiment, the applying the plasticizer composition to at least one of an upper surface or a lower surface of the coated substrate is conducted by applying from 0.005 wt % to 0.06 wt % of the plasticizer composition based on a total weight of the roofing material. In one embodiment, the applying the plasticizer composition to at least one of an upper surface or a lower surface of the coated substrate is conducted by applying from 0.008 wt % to 0.06 wt % of the plasticizer composition based on a total weight of the roofing material. In one embodiment, the applying the plasticizer composition to at least one of an upper surface or a lower surface of the coated substrate is conducted by applying from 0.01 wt % to 0.06 wt % of the plasticizer composition based on a total weight of the roofing material. In one embodiment, the applying the plasticizer composition to at least one of an upper surface or a lower surface of the coated substrate is conducted by applying from 0.02 wt % to 0.06 wt % of the plasticizer composition based on a total weight of the roofing material. In one embodiment, the applying the plasticizer composition to at least one of an upper surface or a lower surface of the coated substrate is conducted by applying from 0.03 wt % to 0.06 wt % of the plasticizer composition based on a total weight of the roofing material. In one embodiment, the applying the plasticizer composition to at least one of an upper surface or a lower surface of the coated substrate is conducted by applying from 0.04 wt % to 0.06 wt % of the plasticizer composition based on a total weight of the roofing material. In one embodiment, the applying the plasticizer composition to at least one of an upper surface or a lower surface of the coated substrate is conducted by applying from 0.05 wt % to 0.06 wt % of the plasticizer composition based on a total weight of the roofing material.

In one embodiment, the applying the plasticizer composition to at least one of an upper surface or a lower surface of the coated substrate is conducted by applying from 0.001 wt % to 0.05 wt % of the plasticizer composition based on a total weight of the roofing material. In one embodiment, the applying the plasticizer composition to at least one of an upper surface or a lower surface of the coated substrate is conducted by applying from 0.003 wt % to 0.05 wt % of the plasticizer composition based on a total weight of the roofing material. In one embodiment, the applying the plasticizer composition to at least one of an upper surface or a lower surface of the coated substrate is conducted by applying from 0.005 wt % to 0.05 wt % of the plasticizer composition based on a total weight of the roofing material. In one embodiment, the applying the plasticizer composition to at least one of an upper surface or a lower surface of the coated substrate is conducted by applying from 0.008 wt % to 0.05 wt % of the plasticizer composition based on a total weight of the roofing material. In one embodiment, the applying the plasticizer composition to at least one of an upper surface or a lower surface of the coated substrate is conducted by applying from 0.01 wt % to 0.05 wt % of the plasticizer composition based on a total weight of the roofing material. In one embodiment, the applying the plasticizer composition to at least one of an upper surface or a lower surface of the coated substrate is conducted by applying from 0.02 wt % to 0.05 wt % of the plasticizer composition based on a total weight of the roofing material. In one embodiment, the applying the plasticizer composition to at least one of an upper surface or a lower surface of the coated substrate is conducted by applying from 0.03 wt % to 0.05 wt % of the plasticizer composition based on a total weight of the roofing material. In one embodiment, the applying the plasticizer composition to at least one of an upper surface or a lower surface of the coated substrate is conducted by applying from 0.04 wt % to 0.05 wt % of the plasticizer composition based on a total weight of the roofing material.

In one embodiment, the applying the plasticizer composition to at least one of an upper surface or a lower surface of the coated substrate is conducted by applying from 0.001 wt % to 0.04 wt % of the plasticizer composition based on a total weight of the roofing material. In one embodiment, the applying the plasticizer composition to at least one of an upper surface or a lower surface of the coated substrate is conducted by applying from 0.003 wt % to 0.04 wt % of the plasticizer composition based on a total weight of the roofing material. In one embodiment, the applying the plasticizer composition to at least one of an upper surface or a lower surface of the coated substrate is conducted by applying from 0.005 wt % to 0.04 wt % of the plasticizer composition based on a total weight of the roofing material. In one embodiment, the applying the plasticizer composition to at least one of an upper surface or a lower surface of the coated substrate is conducted by applying from 0.008 wt % to 0.04 wt % of the plasticizer composition based on a total weight of the roofing material. In one embodiment, the applying the plasticizer composition to at least one of an upper surface or a lower surface of the coated substrate is conducted by applying from 0.01 wt % to 0.04 wt % of the plasticizer composition based on a total weight of the roofing material. In one embodiment, the applying the plasticizer composition to at least one of an upper surface or a lower surface of the coated substrate is conducted by applying from 0.02 wt % to 0.04 wt % of the plasticizer composition based on a total weight of the roofing material. In one embodiment, the applying the plasticizer composition to at least one of an upper surface or a lower surface of the coated substrate is conducted by applying from 0.03 wt % to 0.04 wt % of the plasticizer composition based on a total weight of the roofing material. In one embodiment, the applying the plasticizer composition to at least one of an upper surface or a lower surface of the coated substrate is conducted by applying from 0.001 wt % to 0.03 wt % of the plasticizer composition based on a total weight of the roofing material. In one embodiment, the applying the plasticizer composition to at least one of an upper surface or a lower surface of the coated substrate is conducted by applying from 0.003 wt % to 0.03 wt % of the plasticizer composition based on a total weight of the roofing material. In one embodiment, the applying the plasticizer composition to at least one of an upper surface or a lower surface of the coated substrate is conducted by applying from 0.005 wt % to 0.03 wt % of the plasticizer composition based on a total weight of the roofing material. In one embodiment, the applying the plasticizer composition to at least one of an upper surface or a lower surface of the coated substrate is conducted by applying from 0.008 wt % to 0.03 wt % of the plasticizer composition based on a total weight of the roofing material. In one embodiment, the applying the plasticizer composition to at least one of an upper surface or a lower surface of the coated substrate is conducted by applying from 0.01 wt % to 0.03 wt % of the plasticizer composition based on a total weight of the roofing material. In one embodiment, the applying the plasticizer composition to at least one of an upper surface or a lower surface of the coated substrate is conducted by applying from 0.02 wt % to 0.03 wt % of the plasticizer composition based on a total weight of the roofing material.

In one embodiment, the applying the plasticizer composition to at least one of an upper surface or a lower surface of the coated substrate is conducted by applying from 0.001 wt % to 0.02 wt % of the plasticizer composition based on a total weight of the roofing material. In one embodiment, the applying the plasticizer composition to at least one of an upper surface or a lower surface of the coated substrate is conducted by applying from 0.003 wt % to 0.02 wt % of the plasticizer composition based on a total weight of the roofing material. In one embodiment, the applying the plasticizer composition to at least one of an upper surface or a lower surface of the coated substrate is conducted by applying from 0.005 wt % to 0.02 wt % of the plasticizer composition based on a total weight of the roofing material. In one embodiment, the applying the plasticizer composition to at least one of an upper surface or a lower surface of the coated substrate is conducted by applying from 0.008 wt % to 0.02 wt % of the plasticizer composition based on a total weight of the roofing material. In one embodiment, the applying the plasticizer composition to at least one of an upper surface or a lower surface of the coated substrate is conducted by applying from 0.01 wt % to 0.02 wt % of the plasticizer composition based on a total weight of the roofing material. In one embodiment, the applying the plasticizer composition to at least one of an upper surface or a lower surface of the coated substrate is conducted by applying from 0.001 wt % to 0.01 wt % of the plasticizer composition based on a total weight of the roofing material. In one embodiment, the applying the plasticizer composition to at least one of an upper surface or a lower surface of the coated substrate is conducted by applying from 0.003 wt % to 0.01 wt % of the plasticizer composition based on a total weight of the roofing material. In one embodiment, the applying the plasticizer composition to at least one of an upper surface or a lower surface of the coated substrate is conducted by applying from 0.005 wt % to 0.01 wt % of the plasticizer composition based on a total weight of the roofing material. In one embodiment, the applying the plasticizer composition to at least one of an upper surface or a lower surface of the coated substrate is conducted by applying from 0.008 wt % to 0.01 wt % of the plasticizer composition based on a total weight of the roofing material. In one embodiment, the applying the plasticizer composition to at least one of an upper surface or a lower surface of the coated substrate is conducted by applying from 0.001 wt % to 0.008 wt % of the plasticizer composition based on a total weight of the roofing material. In one embodiment, the applying the plasticizer composition to at least one of an upper surface or a lower surface of the coated substrate is conducted by applying from 0.003 wt % to 0.008 wt % of the plasticizer composition based on a total weight of the roofing material. In one embodiment, the applying the plasticizer composition to at least one of an upper surface or a lower surface of the coated substrate is conducted by applying from 0.005 wt % to 0.008 wt % of the plasticizer composition based on a total weight of the roofing material. In one embodiment, the applying the plasticizer composition to at least one of an upper surface or a lower surface of the coated substrate is conducted by applying from 0.001 wt % to 0.005 wt % of the plasticizer composition based on a total weight of the roofing material. In one embodiment, the applying the plasticizer composition to at least one of an upper surface or a lower surface of the coated substrate is conducted by applying from 0.003 wt % to 0.005 wt % of the plasticizer composition based on a total weight of the roofing material. In one embodiment, the applying the plasticizer composition to at least one of an upper surface or a lower surface of the coated substrate is conducted by applying from 0.001 wt % to 0.003 wt % of the plasticizer composition based on a total weight of the roofing material.

In one embodiment, the substrate comprises one of a fiberglass mat, a polyester mat, a scrim, a membrane, or a combination thereof.

In one embodiment, the applying the plasticizer composition to at least one of an upper surface or a lower surface of the coated substrate is conducted prior to laminating of the roofing material.

In one embodiment, the applying the plasticizer composition to at least one of an upper surface or a lower surface of the coated substrate is conducted prior to applying a sealant or adhesive to at least one of the upper surface or the lower surface of the coated substrate. According to one embodiment, the plasticizer composition is applied to the upper surface and/or the lower surface of the coated substrate prior to applying a sealant or adhesive to the upper surface and/or the lower surface of the coated substrate, in order to not affect the adhesive performance of the sealant or adhesive.

According to one embodiment, the plasticizer composition is applied to the upper surface and/or the lower surface of the coated substrate with adequate curing time to allow for the plasticizer composition to be absorbed into the substrate (e.g., shingle fabric) of the coated substrate and evaporation of any water in the plasticizer composition to not result in excessive moisture for the roofing materials to be packaged in a bundle form.

In one embodiment, the roofing material comprises a roofing shingle.

In an embodiment, the roofing material comprises one of a roofing shingle and a roofing membrane. According to one embodiment, the roofing material comprises a laminated roofing shingle. According to another embodiment, the roofing material is one of (i) a single layer roofing shingle or (ii) a laminated roofing shingle having two or more layers.

In one embodiment, the roofing material exhibits increased flexibility at temperatures of 40° F. or lower, as compared to a roofing material prepared without applying a plasticizer composition.

Another embodiment of this invention pertains to a roofing material prepared by the method described above.

Yet another embodiment of this invention pertains to a method of installing a roofing material that includes obtaining a plurality of roofing materials, with each roofing material of the plurality of roofing materials comprising a coated substrate to which a plasticizer composition has been applied to at least one of an upper surface or a lower surface of the coated substrate, such that the plasticizer composition penetrates into a substrate of the coated substrate, and applying the plurality of roofing materials to a roof deck.

In one embodiment, the coated substrate comprises a substrate that is coated with an asphaltic coating composition.

In one embodiment, the substrate comprises one of a fiberglass mat, a polyester mat, a scrim, a membrane, or a combination thereof.

In one embodiment, each roofing material of the plurality of roofing materials further comprises at least one of roofing granules, fines, back surfacers, surfacing media, or a combination thereof applied to at least one of the upper surface or the lower surface of the coated substrate.

In one embodiment, the plasticizer composition is applied to at least one of an upper surface or a lower surface of the coated substrate in an amount of from 0.001 wt % to 0.05 wt % based on a total weight of the roofing material.

In one embodiment, each roofing material of the plurality of roofing materials further comprises a sealant or adhesive that is applied to at least one of the upper surface or the lower surface of the coated substrate.

In one embodiment, each roofing material of the plurality of roofing materials exhibits increased flexibility when installed at temperatures of 40° F. or lower, as compared to a roofing material that does not include a plasticizer composition.

Another embodiment of this invention pertains to a bundle of roofing materials that includes a plurality of roofing materials, with each roofing material of the plurality of roofing materials comprising a coated substrate to which a plasticizer composition has been applied to at least one of an upper surface or a lower surface of the coated substrate, such that the plasticizer composition penetrates into a substrate of the coated substrate. According to one embodiment, each roofing material of the plurality of roofing materials is configured to be installed on a roof deck at temperatures of 40° F. or lower.

In one embodiment, the coated substrate comprises a substrate that is coated with an asphaltic coating composition.

According to embodiments described herein, roofing materials can be prepared with enhanced ability to conform to the roof deck and/or the ability to relax quickly to lay flat on the roof deck, such that sealants applied to the roofing materials can make contact with the shingle surfaces underneath to provide early tacking and/or wind uplift resistance. This can improve the cold wind performance of roofing materials (e.g., roofing shingles) installed during cold weather. Furthermore, this can be combined with sealants that have improved low temperature tackiness or higher uplift resistance at temperatures at or below 40° F. to further improve wind performance when installed in cold weather.

According to embodiments described herein, roofing materials can be prepared by applying plasticizer compositions (e.g., emulsions) that may contain some level of additives to lower the freezing temperature of water, such that roofing materials containing some level of water will not freeze and become rigid when the ambient temperatures drop below freezing. This is due to the fact that cooling water is used during the shingle making process to cool the shingle after the application of granules and/or back sands to the molten asphalt coating. As a result, some cooling water may be trapped within the bundle of shingles and the shingle may have the potential to freeze up in cold weather.

### EXAMPLES

Specific embodiments of the invention will now be demonstrated by reference to the following examples. It should be understood that these examples are disclosed by way of illustrating the invention and should not be taken in any way to limit the scope of the present invention.

### Example 1

Asphaltic shingle samples were obtained for testing flexibility at cold temperatures to determine their pliability for shingle installation during cold weather. Shingle specimens with a size of 1″×6″ were cut from a single layer area of the shingle along the long direction (or length) of the shingle and were subjected to Mandrel Bend testing using 1″ diameter Mandrel Bend by following the ASTM D3462 test procedure. Prior to the Mandrel Bend testing, the shingle specimens were first conditioned at a temperature of −11° F. for 4 hours and then were tested at the same temperature for their flexibility performance. A second test was conducted by conditioning additional shingle specimens at −20° F. for 4 hours and then testing them for flexibility at the same temperature. A total of 5 shingle specimens were tested at −11° F. and a total of 3 shingle specimens were tested at −20° F.

The shingle samples as obtained in this Example were found to have a 0% passing rate for flexibility according to the Mandrel Bend testing for both the −11° F. and −20° F. temperature samples (see, e.g., Sample A in Table 1 below).

### Example 2

The same asphaltic shingle samples obtained in Example 1 were treated with a soy oil based plasticizer composition to determine the effect of the plasticizer composition on the flexibility of the shingle samples in cold weather. The plasticizer composition was primarily soy oil and was first dispersed in water by adding a surfactant to achieve water-based emulsions at 20% and 5% concentration. The prepared plasticizer compositions (or emulsions) were then sprayed directly onto the surfaces of the shingle samples at room temperature, and left undisturbed for 16 hours to allow the plasticizer to be absorbed into the shingle sample. Shingle specimens were then obtained from the treated shingle samples following the same procedure as in Example 1 and then were tested for their flexibility at −11° F. and −20° F. per the same Mandrel Bend test procedure as in Example 1.

The results of Example 1 and Example 2 are shown in Table 1 below, where the passing rate for the flexibility test (or Mandrel Bend testing) was found to be drastically improved for the shingle samples of Example 2 at the −11° F. temperature, especially for the shingle samples of Example 2 treated on both top and bottom surfaces with 20% emulsions or plasticizer compositions (i.e., Samples B, C, and D). Notable improvement was also noted for the flexibility at −20° F. for the shingle samples of Example 2 treated with the plasticizer composition at 0.036 wt % on both shingle surfaces (i.e., Sample C).

TABLE 1

| | Plasticizer | | Flexibility, 1″ Mandrel | |
|---|---|---|---|---|
| Sample | Amount | Plasticizer | Bend, % Passing | |
| ID | Wt. % | Application Area | at −11° F. | at −20° F. |
| A | None | None | 0% | 0% |
| B | 0.016% | Bottom surface | 80% | 0% |
| C | 0.036% | Top & bottom | 100% | 67% |
| | | surface | | |
| D | 0.022% | Top surface | 60% | 0% |
| E | 0.006% | Bottom surface | 20% | 0% |
| F | 0.012% | Top & bottom | 20% | 0% |
| | | surface | | |
| G | 0.003% | Top surface | 40% | 0% |

As shown in the test results of Table 1 above, for the shingle samples of Example 2 treated with 5% emulsions or plasticizer compositions (i.e., Samples E, F, and G), the improvement of flexibility at −11° F. is still noticeable as compared to the untreated one (i.e., Sample A of Example 1); however, the improvement was not as significant as those treated with 20% emulsions or plasticizer compositions. Also, as shown in Table 1 above, there was no observed improvement for the flexibility at −20° F. for Samples B, D, E, F, or G when compared to the untreated shingle sample of Sample A of Example 1.

### Example 3

Example 3 was conducted to illustrate the improvement to cold-weather flexibility of shingle samples after treatment with a soybean oil plasticizer composition using a “Shingle Lay Flat Study,” which is further described below. In this regard, to test the ability of shingle samples to relax from a distorted state at cold temperatures, a test method entitled “Shingle Lay Flat Study” was developed and is described below. In this test method, a 1″ distortion gap was first introduced to shingle samples at 30° F. and then the amount of the distortion was monitored over time to record the ability of the shingle and/or the shingle performance to lay flat.

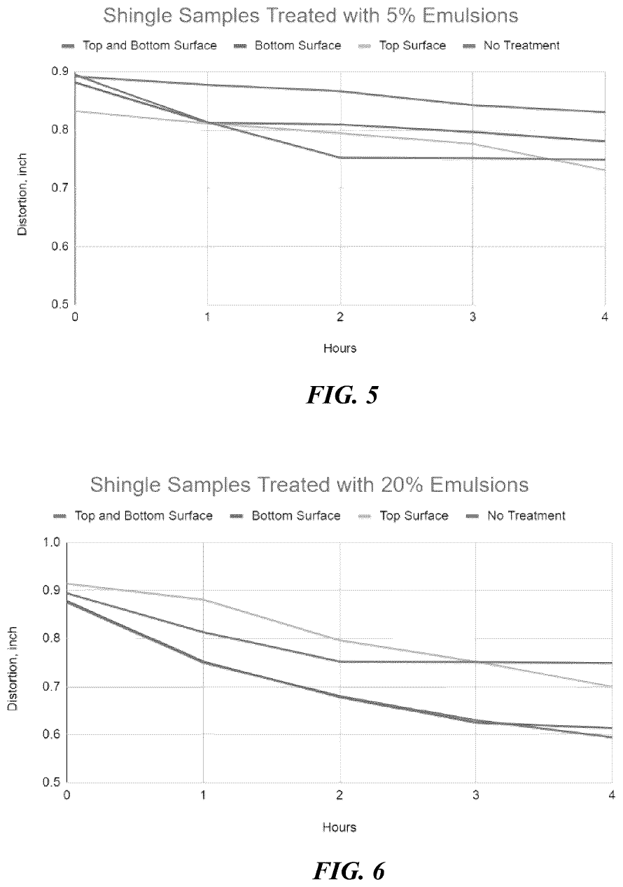

The results of the Shingle Lay Flat Study for this Example 3 are shown in FIGS. 5 and 6. In particular, according to this Example 3, the same shingle samples obtained in Example 1 were tested for their ability to lay flat following the test method described below (i.e., the “Shingle Lay Flat Study”) and the sample(s) was found to only relax down to 0.75″ after 4 hours (see, e.g., FIG. 5 for the sample titled “No Treatment”). For the shingle samples treated with 5% emulsions or plasticizer composition with an average application rate of about 0.57 gm/ft², the ability of the shingle samples to relax from the distorted state showed little improvement and the amount of the distortion was similar to that of the untreated shingle sample after 4 hours (see, e.g., FIG. 5). However, for the shingle samples treated with 20% emulsions or plasticizer composition with an average application rate of about 0.57 μm/ft², the ability of the shingle samples to relax appeared to show a significant improvement and resulted in only about 0.6″ after 4 hours for the shingle samples with application of the plasticizer composition to either the bottom surface or both the top and bottom surfaces (see, e.g., FIG. 6).

### Shingle Lay-Flat Test Method

### Equipment/Materials Needed

This test method requires an environmental chamber with an inside dimension of at least 4′×4′×4′ and capable of heating to 140° F./cooling down to 30° F. Alternatively, one may use an oven for heating conditioning at 140° F. plus a cold box for low-temperature conditioning at 30° F.

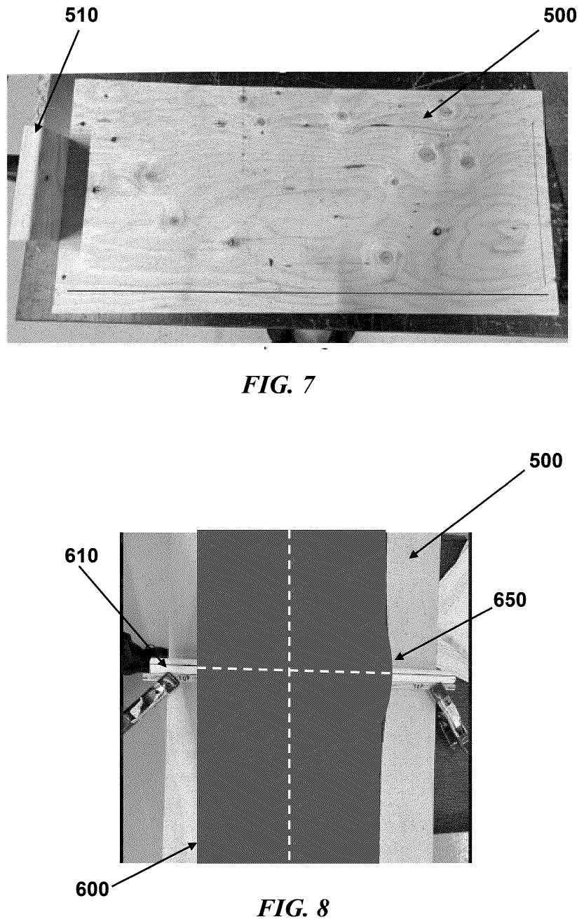

This test method further requires a flat test board constructed of ¾″ plywood with a size of 16″×41″ and a 2″×4″ block added as an end wall for the shingle to butt against. See, e.g., FIG. 7, which illustrates a test board 500 and a block 510 as an end wall for a test shingle to butt against. In addition, this test method further requires (i) a ¾″ Schedule 40 PVC pipe with 1″+ 1/16″ outer diameter and a length of 16″+¼″, and (ii) a vernier caliper or ruler.

### Procedure

A distortion is created in the middle of a shingle sample in the short direction (see, e.g., FIG. 8). For example, to create this mid-point distortion 650 in the short direction of a shingle sample 600, the center of the shingle sample 600 and the test board (or plywood) 500 where the center of the shingle sample 600 will sit are first marked. Then, the selected shingle sample 600 is placed on the test board 500 by aligning the left edge of the shingle sample 600 to the edge of the test board 500 against the block (see, e.g., block 510 of FIG. 7). The left edge of the shingle sample 600 is secured to prevent movement. Next, the 1″+PVC pipe 610 is inserted at the position where the centerline of the PVC pipe 610 is aligned with a mid-point of the shingle sample 600 in the short direction (see, e.g., FIG. 8). Any sealant on the shingle sample 600 should be taped to prevent the shingle sample 600 from sticking to the test board 500 and/or the PVC pipe 610. For example, 1″ masking tape works to tape any sealant.

### Conditioning

The above-described set-up (see, e.g., FIG. 8) is then placed in the environmental chamber described above or a forced-air oven and heated to 140° F. for a minimum of 4 hours to create the distorted configuration. After the heat conditioning, the setup is then cooled to 30° F. and held for at least 12 hours to lock in the distortion. After the shingle sample has been distorted and the distortion locked in at the selected test temperature, the sample is now ready to be measured.

### Measurements

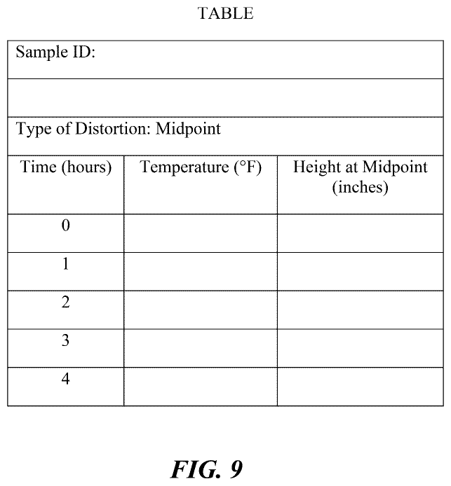

The test is started by carefully removing the inserted PVC pipe (see, e.g., pipe 610 of FIG. 8) without disturbing the shingle sample (see, e.g., shingle sample 600 of FIG. 8), and the height measurement at the peak of the distortion is quickly taken using a ruler or vernier caliper. This peak height and the temperature are recorded as time “0” in a table (see, e.g., Table shown in FIG. 9).

The height measurement is thereafter conducted every four hours, with the height and the temperature recorded in the same table each time (see, e.g., Table shown in FIG. 9). The measurements are stopped once the shingle sample has returned to a laying flat state or the height measurement is less than 1/16″. This final hour interval and height measurement of the shingle is then recorded in the same table (see, e.g., Table shown in FIG. 9).

The results of this test method can then be illustrated as a graph of the time (hours) as the x-axis versus the distortion (inches) as the y-axis (see, e.g., FIGS. 5 and 6).

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A bundle comprising:
a plurality of roofing materials, wherein each roofing material of the plurality of roofing materials comprises:
an asphalt coated substrate comprising:
a substrate;
an asphalt coating on the substrate; and
a plasticizer composition penetrated into the substrate,
wherein each roofing material of the plurality of roofing materials exhibits increased flexibility at temperatures of 40° F. or lower, as compared to a roofing material prepared without applying a plasticizer composition, such that each roofing material of the plurality of roofing materials is configured to be installed on a roof deck at temperatures of 40° F. or lower.

2. The bundle according to claim 1, wherein the substrate comprises one of a fiberglass mat, a polyester mat, a scrim, a membrane, or a combination thereof.

3. The bundle according to claim 1, wherein the plasticizer composition is applied to a lower surface of the asphalt coated substrate.

4. The bundle according to claim 1, wherein the plasticizer composition is applied to both an upper surface and a lower surface of the asphalt coated substrate.

5. The bundle according to claim 1, wherein each roofing material of the plurality of roofing materials further comprises at least one of roofing granules, fines, back surfacers, surfacing media, or a combination thereof applied to a surface of the asphalt coated substrate.

6. The bundle according to claim 1, wherein the plasticizer composition comprises at least one of a low molecular weight oil, naphthenic oil, paraffin oil, mineral oil, cooking oil, olive oil, soybean oil, cashew nut oil or a derivative thereof, flax oil, a plant-derived oil, recycled oil, methyl soyate, epoxidized soy fatty acid esters, or combinations thereof.

7. The bundle according to claim 1, wherein the plasticizer composition comprises a surfactant.

8. The bundle according to claim 1, wherein the plasticizer composition comprises at least one of a viscosity modifier, a surfactant, a biocide, a tackifier, or combinations thereof.

9. The bundle according to claim 1, wherein the plasticizer composition comprises a water-based emulsion at a concentration of from 5% to 20%.

10. The bundle according to claim 1, wherein the plasticizer composition is applied to at least one of an upper surface or a lower surface of the asphalt coated substrate in an amount of from 0.001 wt % to 0.05 wt % based on a total weight of the roofing material.

11. The bundle according to claim 1, wherein each roofing material of the plurality of roofing materials further comprises a sealant or adhesive that is applied to at least one of an upper surface or a lower surface of the asphalt coated substrate.

12. A method comprising:
obtaining a substrate;
obtaining an asphaltic composition;
applying the asphaltic composition to a surface of the substrate to prepare a coated substrate; and
applying a plasticizer composition to a surface of the coated substrate to prepare a roofing material, such that the plasticizer composition penetrates into the substrate of the coated substrate.

13. The method according to claim 12, wherein the applying the plasticizer composition to a surface of the coated substrate is conducted prior to installation of the roofing material on a roof deck.

14. The method according to claim 12, further comprising applying at least one of roofing granules, fines, back surfacers, surfacing media, or a combination thereof to a surface of the coated substrate.

15. The method according to claim 14, wherein the applying the plasticizer composition to a surface of the coated substrate is conducted after the applying at least one of roofing granules, fines, back surfacers, surfacing media, or a combination thereof to a surface of the coated substrate.

16. The method according to claim 12, wherein the applying the plasticizer composition to a surface of the coated substrate is conducted by roll coating, spraying, brush coating, dip coating, electrostatic spraying, curtain coating, or combinations thereof.

17. A method comprising:
obtaining a plurality of roofing materials, with each roofing material of the plurality of roofing materials comprising:
an asphalt coated substrate comprising:
a substrate;
an asphalt coating on the substrate; and
a plasticizer composition penetrated into the substrate; and
applying the plurality of roofing materials to a roof deck.

18. The method according to claim 17, wherein the plasticizer composition is applied to a lower surface of the asphalt coated substrate that contacts the roof deck.

19. The method according to claim 17, wherein the plasticizer composition is applied to both an upper surface and a lower surface of the asphalt coated substrate.

20. The method according to claim 17, wherein the plasticizer composition comprises at least one of a low molecular weight oil, naphthenic oil, paraffin oil, mineral oil, cooking oil, olive oil, soybean oil, cashew nut oil or a derivative thereof, flax oil, a plant-derived oil, recycled oil, methyl soyate, epoxidized soy fatty acid esters, or combinations thereof.
